(19) United States
(12) Patent Application Publication
(10) Pub. No.: US 2015/0373060 A1
(43) Pub. Date: Dec. 24, 2015

(54) Using Smart TV Capabilities to Enhance Audio/Video Call

(71) Applicants: Michael SHMILOV, Rishon Lezion (IL); Igor MAGAZINIK, Ramat Gan (IL); Talmon MARCO, Tampa, FL (US); Sunny MARUELI, Nes Ziona (IL)

(72) Inventors: Michael Shmilov, Rishon LeZion (IL); Igor Magazinik, Ramat Gan (IL); Talmon Marco, Tampa, FL (US); Sunny Marueli, Nes Ziona (IL)

(21) Appl. No.: 14/760,960

(22) PCT Filed: Dec. 30, 2013
(86) PCT No.: PCT/IB2013/061416

§ 371 Date: Jul. 14, 2015

Related U.S. Application Data
(60) Provisional application No. 61/752,624, filed on Jan. 15, 2013.

(51) Int. Cl. H04L 29/06; H04M 7/00

(52) U.S. Cl. CPC H04L 65/1069; H04M 7/006

(57) ABSTRACT

A method of using capabilities of a smart TV to enhance an audio and/or video call, including discovering by a first smartphone a near smart TV; establishing communication between the first smartphone and the smart TV; checking by the first smartphone the smart TV's capabilities; and using the smart TV capabilities to enhance a call between the first smartphone and a second smartphone or to enhance an application running on the first smartphone.

### CROSS-REFERENCE TO RELATED PATENT APPLICATIONS

This patent application claims priority from and is related to U.S. Provisional Patent Application Ser. No. 61/752,624, filed 15 Jan. 2013, this U.S. Provisional Patent Application incorporated by reference in its entirety herein.

### TECHNOLOGY FIELD

The invention relates to data communication between smart devices and particularly to enhancing audio/video smartphone calls using smart TV capabilities.

### BACKGROUND

Smart TVs such as Samsung Smart TV today have the ability to run applications and interact with applications running on other devices (e.g. an Android smartphone).

Users can already use technologies such as Apple's AirPlay to transmit the audio & video to the TV to be viewed on a bigger screen.

Moreover, Smart TVs now come with the ability to record video & audio by integrating a video camera and a microphone.

There are existing technologies to allow discovery and communication between devices that go “near” each other—such as Bluetooth, Apple Bonjour and Qualcomm AllJoyn.

It would be advantageous to use these technologies for benefitting from the smart TV's microphone and camera in improving phone calls or VoIP calls conducted using a smartphone.

### SUMMARY

according to an aspect of the present invention there is provided a method of using capabilities of a smart TV to enhance an audio and/or video call, comprising: discovering by a first smartphone a near smart TV; establishing communication between said first smartphone and said smart TV; checking by said first smartphone the smart TV's capabilities; and using said smart TV capabilities to enhance a call between said first smartphone and a second smartphone.

The capabilities may be selected from the group consisting of: audio decoding/encoding, video decoding/encoding and supported audio/video formats.

The enhancing may comprise: receiving by said first smartphone audio/video data from a second smartphone; encoding said received audio/video data to a format acceptable by said smart TV; communicating said encoded data to said smart TV; and playing said audio/video data on said smart TV.

The enhancing may comprise: capturing audio/video data by said smart TV; communicating said audio/video data to said first smartphone; decoding said received audio/video data; encoding said decoded audio/video data; and communicating said encoded audio/video data to said second smartphone. The call may be a VoIP call.

According to another aspect of the present invention there is provided a method of using capabilities of a smart TV to enhance an application running on a smartphone, comprising: discovering by a smartphone a near smart TV; establishing communication between said smartphone and said smart TV; checking by said smartphone the smart TV's capabilities; and using said smart TV capabilities to enhance an application running on the smartphone. The capabilities may be selected from the group consisting of: audio decoding/encoding, video decoding/encoding and supported audio/video formats.

The enhancing may comprise: encoding audio/video data to a format acceptable by said smart TV; communicating said encoded data to said smart TV; and playing said audio/video data on said smart TV.

### BRIEF DESCRIPTION OF THE DRAWINGS

FIG. 1 shows schematically the existing data route during a standard cellular call or a VoIP call between two smart phones;

FIG. 2 shows schematically the data route during a standard cellular call or a VoIP call between two smart phones according to the present invention.

FIG. 3 is a flowchart showing the steps taken for establishing communication between a smartphone and a Smart TV;

FIG. 4 is a flowchart showing handling of incoming audio/video streams; and

FIG. 5 is a flowchart showing handling of outgoing audio/video streams.

### DETAILED DESCRIPTION OF PREFERRED EMBODIMENTS

The present invention provides a way for the camera & microphone on the smart TV to be used by an application running on another device such as a Samsung S3 smartphone.

For example, when a call is in progress on the primary device (in this case Samsung S3), and the primary device detects the secondary device (Smart TV), it can switch part or all of the call to work through the secondary device (either automatically, or via user request). For example, audio & video can be streamed to the secondary device and played on the bigger screen. Inputs from the secondary device are streamed (either “raw” or after processing—e.g. compression using a specific “codec”) to the primary device, which treats them as coming from just a different device.

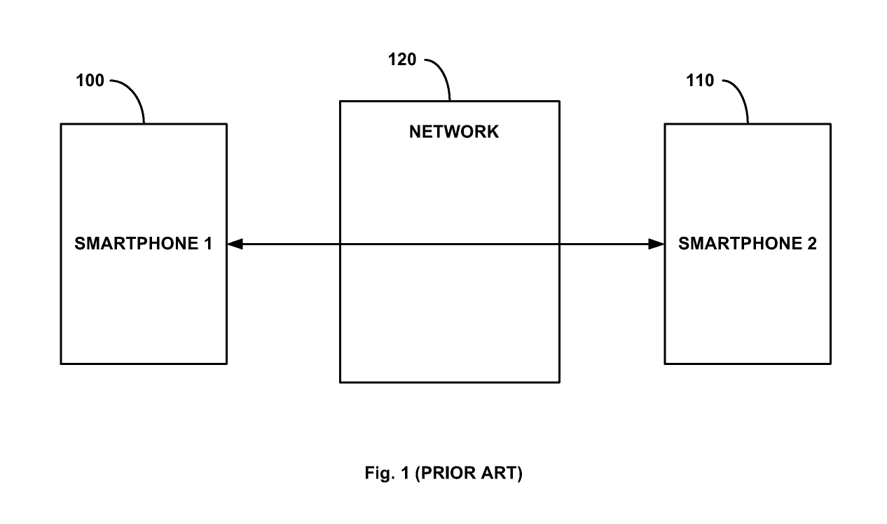

FIG. 1 shows schematically the existing data (audio/video) route during a standard cellular call or a VoIP call between two smart phones. The data is transferred between the 2 endpoints (100, 110) via an appropriate communication channel (GSM/CDMA or Internet, respectively) 120.

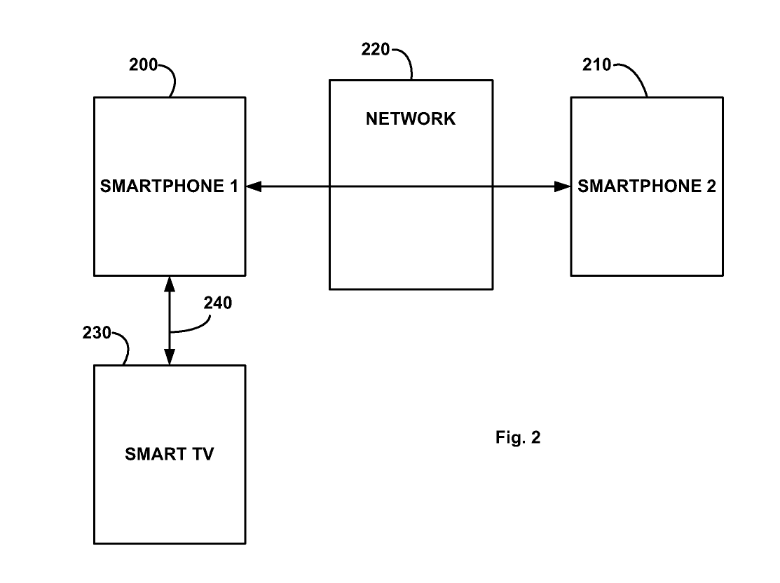

FIG. 2 shows schematically the data (audio/video) route during a standard cellular call or a VoIP call between two smart phones (200, 210) via an appropriate communication channel (GSM/CDMA or Internet, respectively) 220 according to the present invention.

We assume that Smartphone 200 “discovers” a near Smart TV 230, using one of several existing technologies to allow discovery and communication between devices that go “near” each other—such as Bluetooth, Apple Bonjour and Qualcomm AllJoyn.

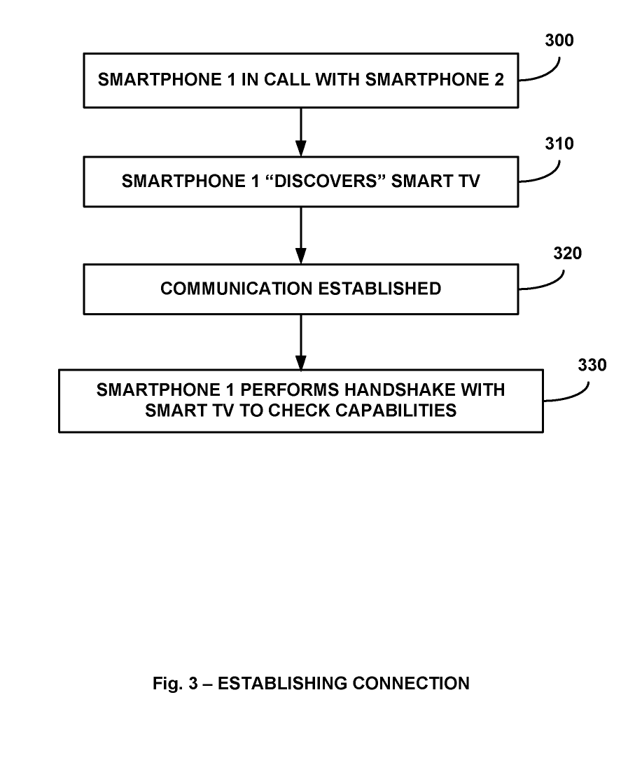

FIG. 3 is a flowchart showing the steps taken for establishing communication between smartphone 200 and Smart TV 230.

In step 300 smartphone 200 is in a call (standard or VoIP) with smartphone 210. It is understood that some negotiation has taken place between the two communicating smartphones to establish formats that can be decoded by each one of them.

In step 310 smartphone 200 “discovers” a nearby Smart TV 230.

It is understood that the “discovery” of Smart TV 230 by smartphone 200 could have taken place before the call start.

In step 320 communication is established between smartphone 200 and smart TV 230 according to the requirement of the technology used (e.g. exchanging passkeys for Bluetooth pairing).

In step 330 smartphone 200 performs handshaking with the Smart TV to checks smart TV 230's capabilities, e.g. whether it is able to record audio and/or video, which formats are supported, etc.

Smartphone 200 can now update the capabilities it advertises to smartphone 210. For example—the TV may be able to decode H264 video, while the smartphone cannot. This may trigger an update where the smartphone reports its extended capabilities.

Once communication has been established and defined, the call between smartphones 200 and 210 may continue with the participation of smart TV 230.

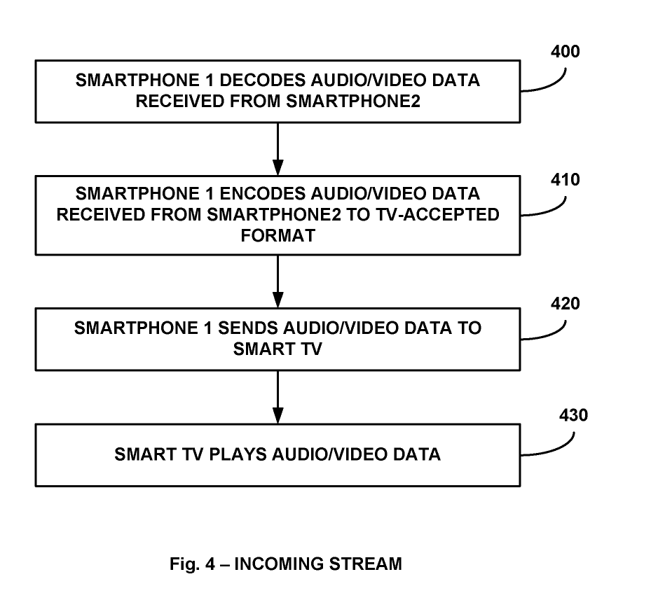

FIG. 4 is a flowchart showing handling of incoming audio/video streams.

In step 400 smartphone 200 decodes audio/video stream received from smartphone 210, using an audio/video codec.

In step 410 smartphone 200 encodes the decoded data into a format acceptable by the smart TV (as determined in step 330).

In step 420 smartphone 200 communicates the formatted data to smart TV 230 using a direct communication channel 240 to which both are connected (e.g. WiFi).

In step 430 smart TV 230 plays/displays the audio/video data.

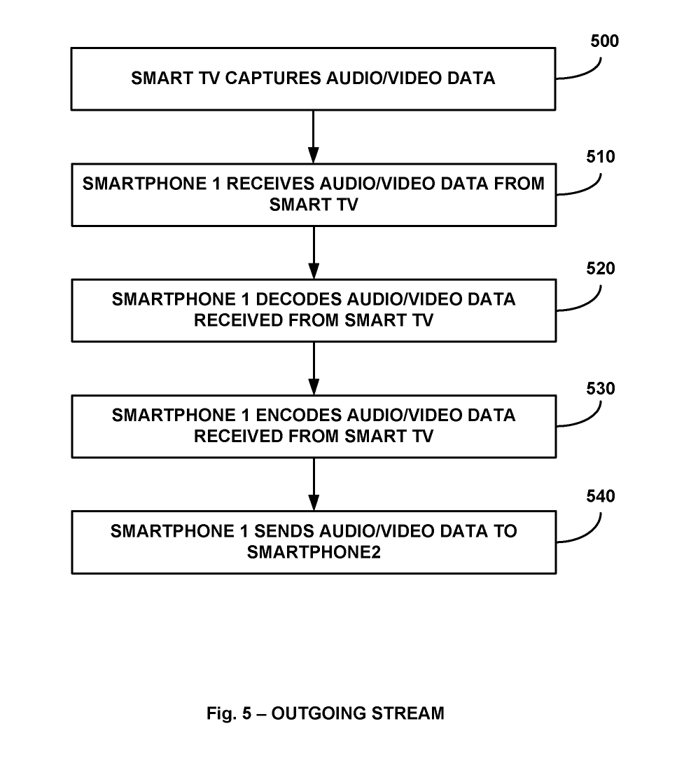

FIG. 5 is a flowchart showing handling of outgoing audio/video streams.

In step 500 smart TV 230 captures audio/video streams using its microphone and/or camera.

In step 510 smartphone 200 receives captured audio/video data from smart TV 230.

In step 520 smartphone 200 decodes the audio/video data received from smart TV 230.

In step 530 smartphone 200 encodes the audio/video data received from smart TV 230 into a format acceptable by smartphone 210.

In step 540 smartphone 200 sends the encoded audio/video data to smartphone 210.

It is understood that the encoding/decoding functionality may be divided between smartphone 200 and smart TV 230 differently, according to smart TV's capabilities. For example, smart TV 230 may have the capability of supplying an audio/video format suitable for communicating to smartphone 210, so that step 530 is not needed.

In another example, a smartphone may not be in a call, but rather run an application comprising audio/video elements. The application can use the camera and/or microphone on the smart TV as proposed hereinabove. For example, an application (running on the smartphone) may take the input from the TV's camera, apply some filter (e.g. stretch parts of the picture for a “funny mirror” effect) and then display the result back on the TV.

1. A method of using capabilities of a smart TV to enhance an audio and/or video call, comprising:
establishing a direct communication between a first smartphone and a second smartphone;
discovering by said a first smartphone a near smart TV;
establishing communication between said first smartphone and said smart TV;
checking by said first smartphone the smart TV's capabilities;
updating said first smartphone capabilities according to said smart TV's capabilities; and
using said smart TV capabilities to enhance said direct communication between said first smartphone and said smartphone;
said capabilities are selected from the group consisting of: audio decoding/encoding, video decoding/encoding and supported audio/video formats.

2. (canceled)

3. The method of claim 1, wherein said enhancing comprises:
receiving by said first smartphone audio/video data from a second smartphone;
encoding said received audio/video data to a format acceptable by said smart TV;
communicating said encoded data to said smart TV; and
playing said audio/video data on said smart TV.

4. The method of claim 1, wherein said enhancing comprises:
capturing audio/video data by said smart TV;
communicating said audio/video data to said first smartphone;
decoding said received audio/video data;
encoding said decoded audio/video data; and
communicating said encoded audio/video data to said second smartphone.

5. The method of claim 1, wherein said call is a VoIP call.

6. A method of using capabilities of a smart TV by an application running on a smartphone, comprising:
discovering by a smartphone a near smart TV;
establishing communication between said smartphone and said smart TV;
checking by said smartphone the smart TV's capabilities; and
using said smart TV capabilities by an application running on the smartphone;
said capabilities are selected from the group consisting of: audio decoding/encoding, video decoding/encoding and supported audio/video formats.

7. (canceled)

8. The method of claim 6, wherein said using comprises:
encoding audio/video data to a format acceptable by said smart TV;
communicating said encoded data to said smart TV; and
playing said audio/video data on said smart TV.
